(19) United States
(12) Patent Application Publication
(10) Pub. No.: US 2009/0288683 A1
(43) Pub. Date: Nov. 26, 2009

(54) ALKALINE PEROXYGEN FOOD SOIL CLEANER

(75) Inventors: Walter D. Cummings, Farmington, MN (US); Robert J. Ryther, St. Paul, MN (US); Richard O. Ruhr, Buffalo, MN (US); Anthony W. Erickson, Golden Valley, MN (US); Peter J. Fernholz, Burnsville, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/124,725

(22) Filed: May 21, 2008

(51) Int. Cl. B08B 7/00; C11D 3/00

(52) U.S. Cl. 134/19; 510/197

(57) ABSTRACT

The present invention relates to compositions and methods for removing soils, e.g., thermally degraded food soils, from surfaces. The cleaning compositions of the present invention can be activated using heat and/or an activator complex to generate oxygen gas in situ on and in the soil to be removed. Surfaces suitable for cleaning using the compositions and methods of the present invention include any surface that can be heated during use and/or cleaning, e.g., smokers, ovens, fryers.

### FIELD OF THE INVENTION

The present disclosure relates to methods for removing soils from hard surfaces by generating a gas or gases on and in the soil to be removed.

### BACKGROUND

In many industrial applications, such as the manufacture of foods and beverages, hard surfaces commonly become contaminated with soils such as carbohydrate, proteinaceous, and hardness soils, food oil soils and other soils. Such soils can arise from the manufacture of both liquid and solid foodstuffs. Carbohydrate soils, such as cellulosics, monosaccharides, disaccharides, oligosaccharides, starches, gums and other complex materials, when dried or burnt on, can form tough, hard to remove soils, particularly when combined with other soil components such as proteins, fats, oils and others. The removal of such carbohydrate soils can be a significant problem. These, in addition to other materials such as proteins, fats and oils and mixtures thereof can also be responsible for the formation of hard to remove soil and residues.

Food and beverage soils are particularly tenacious when they are heated or burnt on to a surface. Foods and beverages are heated for a variety of reasons during processing. For example, in dairy plants, dairy products are heated on a pasteurizer (e.g. HTST—high temperature short time pasteurizer or UHT—ultra high temperature pasteurizer) in order to pasteurize the dairy product. Also, many food and beverage products are concentrated or created as a result of evaporation. Further, other heated cooking surfaces, such as ovens, fryers, and smokehouses, develop a difficult to remove soil from the remnants of food cooked on such surfaces.

### SUMMARY

In some aspects, the present invention provides methods for removing soil from hard surfaces, comprising: (a) applying a cleaning composition comprising an active oxygen source, and a source of alkalinity, wherein the composition is stable for about 4 to about 72 hours at room temperature; (b) activating the composition to generate oxygen gas on and in the soil; and (c) removing the composition from the surface after an amount of time sufficient to facilitate soil removal.

In some embodiments, the active oxygen source is selected from the group consisting of hydrogen peroxide, a peroxycarboxylic acid and combinations thereof. In other embodiments the active oxygen source is present at about 0.1 wt % to about 10 wt %. In still yet other embodiments, the source of alkalinity is present at about 0.1 wt % to about 40 wt %.

In other embodiments, the source of alkalinity is selected from the group consisting of an alkali hydroxide, an alkaline earth hydroxide, an alkanol amine, a silicate salt, a polyphosphate salt, a carbonate salt, a borate salt and combinations thereof. In some embodiments, the cleaning composition further comprises a thickening agent. In other embodiments, the thickening agent is selected from the group consisting of carboxylated vinyl polymers, ethoxylated cellulose, hydroxyethyl styrylamide, polyacrylamide thickeners, xanthan compositions, carrageenan, sodium alginate and algin products, hydroxypropyl cellulose, hydroxyethyl cellulose, quaternary ammonium or amine oxide cationic materials and an anionic counterion, clays, silicates, and combinations thereof.

In still yet other embodiments, the cleaning composition has a cling time before drying of about 0.1 minutes to about 60 minutes. In some embodiments, the cleaning composition further comprises an additional functional ingredient selected from the group consisting of a surfactant, a builder, a buffer, and combinations thereof. In other embodiments, the builder is selected from the group consisting of HEDP, TKPP, PAA, phosphonobutane carboxylic acid, sodium gluconate, EDTA, NTA, STPP, TSP, sodium glucoheptonate, potassium silicate, sodium silicate, and combinations thereof.

In some embodiments, the surfactant is selected from the group consisting of linear alkyl benzene sulfonates, alcohol sulfonates, amine oxides, linear and branched alcohol ethoxylates, alkyl polyglucosides, polyethylene glycol esters, EO/PO block copolymers, and combinations thereof. In other embodiments, the step of activating the composition comprises heating the surface to about 160° F. to about 210° F. before the cleaning composition has been applied to the surface. In some embodiments, the step of activating the composition comprises heating the surface to about 160° F. to about 210° F. after the cleaning composition has been applied to the surface. In still yet other embodiments, the step of activating the composition comprises contacting the cleaning composition with an activator complex.

In some embodiments, the activator complex is applied to the cleaning composition after the cleaning composition has been applied to the surface. In other embodiments, the activator complex is applied to the surface before the cleaning composition has been applied to the surface.

In some embodiments, the activator complex is selected from the group consisting of transition metal complexes, enzymes and combinations thereof. In still yet other embodiments, the transition metal is selected from the group consisting of molybdate, manganese, copper, chromium, iron, cobalt, tin and combinations thereof.

In some embodiments, the composition is applied to the surface for about 1 to about 60 minutes. In still yet other embodiments, the surface is selected from the group consisting of ovens, fryers, smokehouses, and combinations thereof.

In other embodiments, the soil is a food soil. In still yet other embodiments, the food soil is a thermally degraded food soil. In some embodiments, the method further comprises (d) rinsing the surface.

In some aspects, the present invention provides methods for removing a food soil from a hard surface comprising: (a) heating the surface to about 160° F. to about 210° F.; (b) applying a cleaning composition having a cling time of at least about 0.1 minutes to about 60 minutes comprising a peroxygen compound, an alkaline detergent, and a thickening agent, wherein the composition is stable for about 4 to about 72 hours at room temperature; (c) removing the composition from the surface after an amount of time sufficient to facilitate soil removal; and (d) rinsing the surface.

In other aspects, the present invention provides methods for removing a food soil from a hard surface comprising: (a) contacting the surface with an activator complex; (b) applying a cleaning composition having a cling time of at least about 0.1 minutes to about 60 minutes, wherein the composition comprises a peroxygen compound, an alkaline detergent composition, and a thickening agent, wherein the composition is stable for about 4 to about 72 hours at room temperature; (c) heating the surface to about 120° F. to about 210° F.; (d) removing the composition from the surface after an amount of time sufficient to facilitate soil removal; and (e) rinsing the surface.

### DETAILED DESCRIPTION

In some aspects, the present invention relates to methods and compositions for removing soils from hard surfaces. In some embodiments, the compositions are applied to the surfaces to be cleaned manually, i.e., not as a clean in place (CIP) process. In other embodiments, the compositions are manually applied to the surfaces to be cleaned, and are followed thereafter by a conventional CIP process.

The compositions can be mixed on site, and are shelf stable for about 4 to about 72 hours. The compositions are activated, for example, by heat and/or by contact with an activator complex. Once activated, oxygen gas is generated in situ on and in the soil. Without wishing to be bound by any particular theory, it is thought that the generation of oxygen gas on and in the soil enhances soil removal by breaking up the soil cake from within, as opposed to a cleaning solution that simply wets and solubilizes the soil cake.

In order to achieve substantial soil removal, the compositions can comprise a thickening or gelling agent that allows the compositions to cling to the surfaces, both horizontal and vertical, to be cleaned. The ability of the compositions to cling to the surfaces allows for the user or applicator to have a sufficient amount of time in which to activate the cleaning compositions, without concern for the product dissipating or running off of the selected surface.

So that the invention may be readily understood, certain terms are first defined.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about” , the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “cleaning” refers to a method used to facilitate or aid in soil removal, bleaching, microbial population reduction, and any combination thereof.

### Compositions of the Present Invention

In some aspects, the present invention provides methods for removing soils, e.g., food soils, from a surface using a cleaning composition comprising an active oxygen source, and a source of alkalinity. At least one thickener or gelling agent, and at least one additional soil removal agent can also be included in the cleaning composition, as well as other additional functional ingredients. The cleaning composition for use with the methods of the present invention is formulated such that it has a shelf life, i.e., is stable, at room temperature for at least about 3 hours. As used herein, the term “stable” or “shelf stable” refers to the ability of the active oxygen source in the composition to remain active, i.e., not to substantially decompose, over a specified amount of time. That is, the active oxygen source within the cleaning composition does not substantially decompose at room temperature for a certain amount of time after the composition is formulated. In some embodiments, the composition can be stable for about 4 to about 72 hours. In some embodiments, substantial degradation comprises about 10% degradation of the active oxygen source at room temperature within about three hours.

In some embodiments, the composition can be mixed on site prior to the application of the cleaning composition to the selected surface. This stability allows for safe manual application of the cleaning composition while still achieving acceptable cleaning performance, i.e., soil removal.

Active Oxygen Source

In some embodiments, the cleaning composition of the present invention comprises an active oxygen source. As used herein, the term “active oxygen source,” refers to any composition capable of generating oxygen gas in situ on and in a soil once activated. In some embodiments, the active oxygen source is activated by contact with an activator complex. In other embodiments, the active oxygen source is activated by the application of heat. In still yet other embodiments, the active oxygen source is activated by a combination of an activator complex, and the application of heat to the cleaning composition and/or surface to be cleaned.

In some embodiments, the active oxygen source is a compound capable of providing oxygen gas in situ on and in the soil. The compound can be organic, or inorganic. Preferred active oxygen sources release active oxygen gas in aqueous solutions, as well as on and in the soils contacted with the active oxygen source.

Exemplary active oxygen sources for use in the methods of the present invention include, but are not limited to, peroxygen compounds, perborates, persulfates, and gaseous oxidants such as ozone, oxygen, and derivatives thereof. Without wishing to be bound by any particular theory, it is thought that reaction of the active oxygen source with the soil, once activated, creates vigorous mechanical action on and within the soil due to the oxygen gas released. It is thought that this mechanical action enhances removal of the soil beyond that caused by the chemical and bleaching action of the active oxygen source alone.

In some embodiments, the cleaning composition comprises at least one peroxygen compound as an active oxygen source. Peroxygen compounds, including, but not limited to, peroxides and various percarboxylic acids, including percarbonates, can be used with the methods of the present invention. Peroxycarboxylic (or percarboxylic) acids generally have the formula R(CO₃H)ₙ, where, for example, R is an alkyl, arylalkyl, cycloalkyl, aromatic, or heterocyclic group, and n is one, two, or three, and named by prefixing the parent acid with peroxy. The R group can be saturated or unsaturated as well as substituted or unsubstituted. Medium chain peroxycarboxylic (or percarboxylic) acids can have the formula R(CO₃H)ₙ, where R is a C₅-C₁₁ alkyl group, a C₅-C₁₁ cycloalkyl, a C₅-C₁₁ arylalkyl group, C₅-C₁₁ aryl group, or a C₅-C₁₁ heterocyclic group; and n is one, two, or three. Short chain perfatty acids can have the formula R(CO₃H)ₙ where R is C₁-C₄ and n is one, two, or three.

Exemplary peroxycarboxylic acids for use with the present invention include, but are not limited to, peroxypentanoic, peroxyhexanoic, peroxyheptanoic, peroxyoctanoic, peroxynonanoic, peroxyisononanoic, peroxydecanoic, peroxyundecanoic, peroxydodecanoic, peroxyascorbic, peroxyadipic, peroxycitric, peroxypimelic, or peroxysuberic acid, mixtures thereof, or the like.

Branched chain peroxycarboxylic acids include peroxyisopentanoic, peroxyisononanoic, peroxyisohexanoic, peroxyisoheptanoic, peroxyisooctanoic, peroxyisonananoic, peroxyisodecanoic, peroxyisoundecanoic, peroxyisododecanoic, peroxyneopentanoic, peroxyneohexanoic, peroxyneoheptanoic, peroxyneooctanoic, peroxyneononanoic, peroxyneodecanoic, peroxyneoundecanoic, peroxyneododecanoic, mixtures thereof, or the like.

Additional exemplary peroxygen compounds for use with the methods of the present invention, include hydrogen peroxide (H₂O₂), peracetic acid, peroctanoic acid, a persulphate, a perborate, or a percarbonate. In some embodiments, the cleaning composition comprises hydrogen peroxide as an active oxygen source.

In some aspects, the cleaning composition of the present invention comprises at least one active oxygen source. In some embodiments, the cleaning composition comprises at least two, at least three, or at least four active oxygen sources. In other embodiments, the cleaning composition can include multiple active oxygen sources, for example, active oxygen sources that have a broad carbon chain length distribution. In still yet other embodiments, combinations of active oxygen sources for use with the methods of the present invention can include, but are not limited to, peroxide/peracid combinations, and peracid/peracid combinations. In other embodiments, the active oxygen use solution comprises a peroxide/acid or a peracid/acid composition.

The amount of active oxygen source in the cleaning composition is dependent on a variety of factors including, for example, the type of surface to be cleaned, and the amount and type of soil present on the surface. In some embodiments, the amount of active oxygen source included in the cleaning composition is about 0.1 wt-% to about 10 wt-% of the cleaning composition. Acceptable levels of active oxygen source present are about 0.5 to about 2.5 wt-%. It is to be understood that all values and ranges between these values and ranges are encompassed by the present invention.

Source of Alkalinity

In some aspects, the cleaning compositions of the present invention comprise a source of alkalinity. Examples of suitable alkaline sources include basic salts, amines, alkanol amines, carbonates and silicates. Particularly preferred alkaline sources include alkali or alkaline earth metal hydroxide, and MEA (monoethanolamine).

In some embodiments, the source of alkalinity comprises an alkali or alkaline earth metal hydroxide, for example, sodium hydroxide (NaOH), lithium hydroxide, calcium hydroxide, and/or potassium hydroxide (KOH ). Other alkalinity sources suitable for use in the compositions and methods of the present invention include, but are not limited to, silicate salts, amines, alkanol amines, phosphate salts, polyphosphate salts, carbonate salts, borate salts, and combinations thereof. For example, the source of alkalinity can comprise sodium silicate, sodium metasilicate, sodium orthosilicate, sodium phosphate, sodium polyphosphate, sodium borate, sodium carbonate, potassium silicate, potassium metasilicate, potassium orthosilicate, potassium phosphate, potassium polyphosphate, potassium borate, potassium carbonate, lithium silicate, lithium metasilicate, lithium orthosilicate, lithium phosphate, lithium polyphosphate, lithium borate, lithium carbonate, and combinations thereof.

In some embodiments, the cleaning compositions of the present invention comprise about 0.1 wt % to about 40 wt % of a source of alkalinity. In some embodiments, the source of alkalinity is present at about 0.1 wt % to about 12 wt % of the cleaning composition. In other embodiments, the cleaning compositions comprise about 0.5 wt % to about 10 wt % of a source of alkalinity. In still yet other embodiments, the cleaning compositions comprise about 2 wt % of a source of alkalinity. It is to be understood that all values and ranges between these values and ranges are encompassed by the present invention.

### Gelling or Thickening Agents

In some embodiments, the compositions of the present invention comprise a gelling or thickening agent. The gelling or thickening agent aids in the application of the cleaning compositions to the surface to be cleaned. That is, the gelling or thickening agent allows for the cleaning compositions of the present invention to remain on the selected surface for a sufficient amount of time to facilitate soil removal.

In some embodiments, a sufficient amount of a gelling or thickening agent is present in the compositions of the present invention such that the compositions have a cling time, before drying out, of at least about 0.1 minutes. As used herein, the term “cling time” refers to the amount of time which a composition of the present invention can remain on a vertical surface before dissipating or running off the surface, or drying out. For example, in some embodiments, the compositions of the present invention have a cling time of at least about an hour.

In some embodiments, the compositions of the present invention can include organic polymer thickeners of the vinyl polymer type, such as polymers derived from vinyl acetals, vinyl acetates, vinyl alcohols, vinyl chlorides, vinyl ether monomers and polymers, n-vinyl monomers and polymers, and/or vinyl fluorides. Other vinyl polymers which can be used include, for example, vinyl acyl ethyl polymers; n-vinyl amide polymers; styrene polymers including vinyl benzene polymers; vinyl butyryl polymers including vinyl acetyl polymers; vinyl carbazole polymers; vinyl ester polymers including vinyl acetate polymers, as well as other vinyl esters of normal saturated aliphatic acids including formic, propanoic, butyric, valeric,and caproic; vinyl esters of aromatic acids including benzoic, chlorobenzoic, nitrobenzoic, cyanobenzoic, and naphthoic; as well as vinyl ether polymers.

In some embodiments, vinyl polymers prepared from acrylic acid and its derivatives are used in the compositions of the present invention. Generally, acrylates are derivatives of both acrylic and methacrylic acid. Hydrophilic monomers may also be utilized to produce the vinyl polymer for use in the compositions of the present invention, including, acids and acid-esters of alpha, beta-unsaturated carboxylic acids such as methacrylic acid, acrylic acid, itaconic acid, aconitic acid, crotonic acid, mesaconic acid, carboxyethyl acrylic acid, maleic acid, and fumaric acid. Useful acrylic polymers and copolymers for this invention can include methacrylate, ethylacrylate, propylacrylate, isopropylacrylate, and butylacrylate, sesquibutylacrylate, isobutylacrylate, tertbutylacrylate, hexylacrylate, heptylacrylate, 2-heptylacrylate, 2-ethylhexylacrylate, 2-ethylbutylacrylate, dodecylacrylate, hexadecylacrylate, 2-ethoxyethylacrylate, cyclohexylacrylate polymers and mixtures thereof. These thickeners can also include polyvinyl alcohol (with varying degrees of hydrolysis), ethylene/acrylic acid copolymers, ethylene/maleic anhydride copolymers, and styrene/maleic anhydride copolymers.

In addition, naturally derived organic polymer thickeners can be used, such as, for example, casein compositions, natural and naturally derived gum compositions including karaya gum and guar gum, xanthan compositions, e.g., xanthan gum; carrageenan; sodium alginate, and algin product; hydroxypropyl cellulose; hydroxyethyl cellulose, starch-grafted copolymers cellulosic and ether cellulosic compositions, starch, protein compositions ethoxylated cellulose are also useful as thickening polymers of the present invention.

In some embodiments, a surfactant thickening agent is included in the compositions of the present invention. Suitable surfactant thickening agents include those as described in Akzo-Nobel Inc. literature “Cationic Surfactants as Thickening Agents in Hard Surface Cleaners”, H. Rörig and R. Stephan. Suitable thickeners are also as described in U.S. Pat. Nos. 6,268,324 and 6,630,434 which are based on rod micellar surfactant systems, the entire contents of which are hereby incorporated by reference. In some embodiments, a nitrogen containing amine, quaternary ammonium or amine oxide cationic materials and an anionic counterion which form a rod micellar thickener composition are used in the compositions of the present invention. Common useful cationics include trialkylamines, amines having one or two alkyl groups and correspondingly two or one alkylene oxide groups, preferably ethylene oxide groups; commonly available quaternary ammonium compounds can be used wherein the quaternary ammonium compound is made from aliphatic amines, aromatic amines or alkyl substituted aromatic amine substituents and trialkylamine oxides. Anionic counterions, in particular aromatic anionic counterions work effectively to stabilize the micellar surface resulting in the tendency that even the more soluble cationic surfactants can form stable rod micelles in the presence of stabilizing aromatic counterions. Similarly, additional cationic and anionic surfactants can aid in stabilizing micelle formation. Preferable among such cationic surfactants are quaternary ammonium salts, in which at least one higher molecular weight group and two or three lower molecular weight groups are linked to a common nitrogen atom to produce a cation, and wherein the electrically balancing anion is a halide, acetate, nitrite or lower alkosulfate, such as bromide, chloride or methosulfate.

The compositions of the present invention can also comprise inorganic thickeners for example, naturally occurring and synthetic clays; and/or finely divided fumed or precipitated silica. The thickeners for use in the compositions of the present can be aqueous or non-aqueous solutions.

In some embodiments, at least one thickener or gelling agent is present in a cleaning composition of the present invention. In other embodiments, at least two, at least three or at least four gelling or thickening agents are present in a cleaning composition of the present invention.

In some embodiments, the cleaning compositions of the present invention comprise about 0.005 wt % to about 10 wt % of a thickening agent. In some embodiments, the thickening agent is present at about 0.1 wt % to about 4 wt % of the cleaning composition. In still yet other embodiments, the cleaning compositions comprise about 1 wt % of a thickening agent. It is to be understood that all values and ranges between these values and ranges are encompassed by the present invention.

Penetrants

In some aspects, a penetrant may be present in the cleaning composition of the present invention. The penetrant may be combined with an alkaline source in the cleaning composition, or, the penetrant may be used without an alkaline source. Preferably, the penetrant is water miscible.

Examples of suitable penetrants include alcohols, short chain ethoxylated alcohols and phenol (having 1-6 ethoxylate groups). Organic solvents are also suitable penetrants. Examples of suitable organic solvents, for use as a penetrant, include esters, ethers, ketones, amines, and nitrated and chlorinated hydrocarbons.

Another preferred class of penetrants is ethoxylated alcohols. Examples of ethoxylated alcohols include alky, aryl, and alkylaryl alkloxylates. These alkloxylates can be further modified by capping with chlorine-, bromine-, benzyl-, methyl-, ethyl-, propyl-, butyl- and alkyl-groups. A preferred level of ethoxylated alcohols in the cleaning composition is 0.1 to 20 wt-%.

Another class of penetrants is fatty acids. Some non-limiting examples of fatty acids are C₆ to C₁₂ straight or branched fatty acids. Preferred fatty acids are liquid at room temperature.

Another class of preferred solvents for use as penetrants is glycol ethers, which are water soluble. Examples of glycol ethers include dipropylene glycol methyl ether (available under the trade designation DOWANOL DPM from Dow Chemical Co.), diethylene glycol methyl ether (available under the trade designation DOWANOL DM from Dow Chemical Co.), propylene glycol methyl ether (available under the trade designation DOWANOL PM from Dow Chemical Co.), and ethylene glycol monobutyl ether (available under the trade designation DOWANOL EB from Dow Chemical Co.). A preferred level of glycol ether in the solution is 1.0 to 20 wt-%.

Surfactants also are a suitable penetrant for use in the cleaning compositions of the present invention. Examples of suitable surfactants include nonionic, cationic, and anionic surfactants. Nonionic surfactants are preferred. Nonionic surfactants improve soil removal and can reduce the contact angle of the solution on the surface being treated. Examples of suitable nonionic surfactants include alkyl-, aryl-, and arylalkyl-, alkoxylates, alkylpolyglycosides and their derivatives, amines and their derivatives, and amides and their derivatives. Additional useful nonionic surfactants include those having a polyalkylene oxide polymer as a portion of the surfactant molecule. Such nonionic surfactants include, for example, chlorine-, benzyl-, methyl-, ethyl-, propyl-, butyl- and other like alkyl-capped polyoxyethylene and/or polyoxypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines and other like nonionic compounds. Silicone surfactants can also be used.

Additional suitable nonionic surfactants having a polyalkylene oxide polymer portion include nonionic surfactants of C₆-C₂₄ alcohol ethoxylates having 1 to about 20 ethylene oxide groups; C₆-C₂₄ alkylphenol ethoxylates having 1 to about 100 ethylene oxide groups; C₆-C₂₄ alkylpolyglycosides having 1 to about 20 glycoside groups; C₆-C₂₄ fatty acid ester ethoxylates, propoxylates or glycerides; and C₄-C₂₄ mono or dialkanolamides.

In some embodiments, the surfactant is selected from the group consisting of linear alkyl benzene sulfonates, alcohol sulfonates, amine oxides, linear and branched alcohol ethoxylates, alkyl polyglucosides, alkyl phenol ethoxylates, polyethylene glycol esters, EO/PO block copolymers and combinations thereof.

If a surfactant is used as a penetrant, the amount of surfactant in the cleaning composition is about 2.5%. Acceptable levels of surfactant include about 0.1 to about 8 wt-%, and about 1 to about 4 wt-%.

Builders

In some embodiments, the cleaning composition includes a builder or builders. Builders include chelating agents (chelators), sequestering agents (sequestrants), detergent builders, and the like. The builder systems can act to solubilize the soil, as well as to stabilize the cleaning solution relative to precipitation of water hardness components. The builder and sequestrant types can generally be mixed to improve performance depending on the makeup of the sequestered species in the cleaning solution of interest. Preferred builders are water soluble.

Examples of builders and sequestrants for use with the present invention include, but are not limited to, alkali metal pyrophosphate and/or an alkali metal polyphosphate, condensed and cyclic phosphates, phosphonic acids and phosphonates. Particularly preferred phosphorous containing builders and sequestrants include sodium tripolyphosphate (STPP) available in a variety of particle sizes, TKPP (tripotassium polyphosphate), phosphonobutane carboxylic acid, TSP (trisodium phosphate, HEDP (1-Hydroxyethylidene-1,1- Diphosphonic Acid), PBTC (Phosphonobutane-tricarboxylic acid), ATMP (aminotrismethylene-phosphonic acid).

In some embodiments, builders and sequestrants for use with the present invention include aminocarboxylates and their derivatives, ethylenediamine and ethylenetriamine derivatives, nitriloacetates and their derivatives, and mixtures thereof. Particularly preferred aminocarboxylate builders and sequestrants include the acid form, alkali metal salts and ammonium salts of ethylenediaminetetraacetic acid (EDTA), hydroxyethylenediaminetetraacetic acid (HEDTA), diethylenetriaminepentaacetic acid, N-hydroxyethyliminodiacetic acid, nitrilotriacetic acid (NTA) and diethylenetriaminepentaacetic acid (DTPA).

In other embodiments, examples of builders and sequestrants include hydroxyl acids, and mono-, di-, and tri-carboxylates and their corresponding acids. Particularly preferred organic acid builders and sequestrants include the acid form, alkali metal salts and ammonium salts of acetic acid, citric acid, lactic acid and malonic acid, maleic acid, tartaric acid, propionic acid, oxalic acid, gluconic acid, glucoheptonoic acid and hydroxyacetic acid.

In still yet other embodiments, examples of builders and sequestrants for use with the present invention include aluminosilicates and alkali metal salts and ammonium salts of silicates.

In other embodiments, examples of builders and sequestrants include polyelectrolytes such as water soluble acrylic polymers such as polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, hydrolyzed methacrylamide, hydrolyzed acrylamide-methacrylamide copolymers, and combinations thereof. Such polymers, or mixtures thereof, include water soluble salts or partial salts of these polymers such as their respective alkali metal (for example, sodium or potassium) or ammonium salts can also be used. The weight average molecular weight of the polymers is from about 4000 to about 12,000. Preferred polymers include polyacrylic acid, the partial sodium salts of polyacrylic acid or sodium polyacrylate having an average molecular weight within the range of 4000 to 8000.

The amount of builder or sequestrant in the cleaning composition, if present, is generally present in concentrations ranging from about 0.01 wt-% to about 50 wt-%, preferably from about 0.1 wt-% to about 20 wt-%, and most preferably from about 0.5 wt-% to about 15 wt-%.

Activator Complex

In some aspects, the cleaning composition of the present invention comprises an activator complex. In other aspects, the present invention provides a method for cleaning a surface comprising applying an activator complex to a surface either before or after a cleaning composition of the present invention has been applied to the surface. As used herein the term “activator complex” or “activation complex” refers to a composition capable of reacting with an active oxygen source to produce oxygen gas in situ on and in the soil. Without wishing to be bound by any particular theory, it is thought that in some embodiments, activating the active oxygen source is accomplished by a combination of increased alkalinity, increased temperature, and/or addition of an activator complex.

Activator complexes for use in the present invention include, but are not limited to, transition metal complexes, and catalase enzymes. An activator complex for use with the present invention can also include non-chemical based sources, for example, UV light. The activator complex or complexes selected is dependent on a variety of factors including, for example, the active oxygen use solution selected, the surface to be cleaned, and the amount and type of soil to be removed.

In some embodiments, the activator complex comprises a metal. Metals for use in the present invention include, for example, iron and copper. The metal selected is capable of activating the active oxygen source in order to facilitate oxygen generation at a lower temperature than the reaction temperature of the active oxygen source when used without the metal. In some embodiments, the activator complex comprises a transition metal complex. As used herein the term “transition metal complex” refers to a composition comprising a transition metal, i.e., any element contained within the d-block on the periodic table, i.e., groups 3 through 12 on the periodic table. Exemplary transition metals suitable for use in the methods of the present invention include, but are not limited to, manganese, molybdenum, chromium, cobalt and mixtures and derivatives thereof.

In other embodiments, the activator complex comprises a composition comprising a catalase enzyme capable of activating the active oxygen source such that oxygen gas is released on and in the soil. The activator complex can be present in any form suitable for use with the methods of the present invention. For example, in some embodiments the activator complex is included as part of the cleaning composition of the present invention. In other embodiments, the activator complex is applied to the surface to be cleaned either before or after the cleaning composition of the present invention is applied to the surface.

Without wishing to be bound by any particular theory, it is thought that the activator complex for use with the methods of the present invention facilitates and enhances the ability to clean surfaces at reduced temperatures. That is, the use of an activator complex allows for oxygen gas production on and in the soil to be removed at lower temperatures than would be needed without the activator complex to achieve substantially identical soil removal. Such oxygen production aids in facilitating soil removal by generating mechanical action on and in the soil, in addition to the normal bleaching and cleaning action of an oxygen producing source. It is thought that the active oxygen source penetrates the soil. When the active oxygen source within the soil is contacted by the activator complex, oxygen gas is produced within the soil. As the oxygen gas is being produced, it breaks up the soil from within. The broken up soil can then be easily removed, for example, by rinsing or wiping the surface.

The amount of activator complex used in the methods of the present invention is dependent on a variety of factors including, but not limited to, the active oxygen source present in the cleaning composition, the type of surface to be cleaned, and the amount and type of soil present on the surface. The amount of activator complex used is also dependent on the size the particular activator complex chosen.

In some embodiments, the amount of activator complex applied is about 0.0005 wt-% to about 1.0 wt-% of the cleaning composition of the present invention in which it is applied to the surface. In some embodiments, the amount of activator complex applied directly to the surface to be cleaned is about 0.001 wt % to about 0.5 wt %. Acceptable levels of activator complex present are about 0.005 to about 0.1 wt-%; 0.01 wt-% is a particularly suitable level.

### Methods of Cleaning

In some aspects, the present invention provides methods for removing soils from a surface, e.g., a hard surface. In some embodiments, the method comprises applying a cleaning composition to the surface, activating the composition to generate oxygen gas on and in the soil, and removing the composition from the surface after an amount of time sufficient to facilitate soil removal. In some embodiments, the method further comprises rinsing the surface. In some embodiments, the cleaning composition comprises an active oxygen source and a source of alkalinity.

The methods of the present invention can be used to remove a variety of soils from a variety of surfaces. For example, surfaces suitable for cleaning using the methods of the present invention include, but are not limited to, walls, floors, dishes, flatware, pots and pans, heat exchange coils, ovens, fryers, smoke houses, sewer drain lines, and vehicles. Any soiled surface that can be heated, or that is at a temperature such that application of an activator complex and a cleaning composition of the present invention will allow for oxygen gas production on and in the soil, can be cleaned using the methods of the present invention.

The methods of the present invention can be used generally in any application where thermally degraded soils, i.e., caked on soils or burned on soils, such as proteins or carbohydrates, need to be removed. As used herein, the term “thermally degraded soil” refers to a soil or soils that have been exposed to heat and as a result have become baked on to the surface to be cleaned. Exemplary thermally degraded soils include food soils that have been heated during processing, e.g., dairy products heated on pasteurizers, or food soils that remain on a surface used for cooking, e.g., food soils left on smokers, cook tops or fryers.

The methods of the present invention can also be used to remove other non-thermally degraded soils that are not easily removed using conventional cleaning techniques. The methods of the present invention provide enhanced cleaning of these hard to remove soil types. Soil types best suited to cleaning with the methods of the present invention include, but are not limited to, starch, cellulosic fiber, protein, simple carbohydrates and combinations of any of these soil types with mineral complexes. Examples of specific food soils that are effectively removed using the methods of the present invention included, but are not limited to, vegetable and fruit juices, brewing and fermentation residues, soils generated in sugar beet and cane processing, and soils generated in condiment and sauce manufacture, e.g., ketchup, tomato sauce, barbeque sauce. These soils can develop on heat exchange equipment surfaces and on other surfaces during the manufacturing and packaging process.

Exemplary industries in which the methods of the present invention can be used include, but are not limited to: the food and beverage industry, e.g., the dairy, cheese, sugar, and brewery industries; oil processing industry; industrial agriculture and ethanol processing; and the pharmaceutical manufacturing industry.

In some embodiments, the step of activating the cleaning composition comprises heating the composition. Temperatures suitable for activating the compositions of the present invention range from about 100° F. to about 300° F. In some embodiments, the activation temperature is between about 160° F. and about 210° F.

Activation by heating the composition can be achieved in a variety of ways. For example, in some embodiments, the surface to be cleaned is heated in order to activate the cleaning composition. The surface can be heated before or after the cleaning composition is applied. The surface can also be heated substantially simultaneously as the application of the cleaning composition.

In other embodiments, the cleaning composition is activated by contact with an activator complex. The cleaning composition can be contacted with an activator complex in a multitude of ways. For example, in some embodiments, a cleaning composition is applied to the surface to be cleaned. An activator complex is then applied on top of the cleaning composition. The activator complex and/or the cleaning composition can be applied to the surface by any suitable means including, but not limited to, by being sprayed, or poured on to the surface. Alternatively, in some embodiments, the surface may be a removable part that can be dipped into the selected activator complex or cleaning composition. The surface may or may not be heated. That is, in some embodiments, the surface is heated before during or after the application of the cleaning composition, and/or the application of the activator complex. In other embodiments, the surface is not heated before, during, or after the cleaning process.

In other embodiments, an activator complex is first applied to a surface to be cleaned. The cleaning composition is then applied over the activator complex. The surface may or may not be heated before, during, or after the application of either the activator complex, or the cleaning composition.

In some embodiments, the methods of the present invention are followed by only a rinse step. In other embodiments, the methods of the present invention are followed by a conventional CIP method suitable for the surface to be cleaned. In still yet other embodiments, the methods of the present invention are followed by a CIP method such as those described in U.S. patent application Ser. Nos. 10/928,774 and 11/257,874 entitled “Methods for Cleaning Industrial Equipment with Pre-treatment,” both of which are hereby incorporated by reference in their entirety.

For a more complete understanding of the invention, the following examples are given to illustrate some embodiments. These examples and experiments are to be understood as illustrative only and not limiting.

### EXAMPLES

The following materials, methods, and examples are meant to be illustrative only and are not intended to be limiting.

The following examples were performed to determine the cleaning capabilities of an all-in-one peroxygen/caustic composition to remove soils. The percent soil removal for these examples was calculated using the following formula:

$$\frac{Soiled wt - After wt}{Soiled wt - virgin wt} \times 100 = \% Soil Removal ( \% SR )$$

The following peroxygen cleaner was used as a component of the all-in-one composition: 74% hydrogen peroxide (35%), 9.75% sodium cumene sulfonate (40%), 5.25% sodium octane sulfonate, 3.50% hydroxyethylidene diphosphonic acid (60%), 3% methane sulfonic acid, 1% n-butyl capped alcohol ethoxylate (5 EO), and 3.5% pelargonic acid. The cleaning tests performed are described in more detail below.

### Example 1

### Use of a Gelled Peroxygen/Caustic Cleaner

The ability of an all-in-one peroxygen/caustic cleaner to remove corn oil/lard from stainless steel plates was determined.

Ten (10) grams of corn oil, and three grams of lard were polymerized onto stainless steel plates. To polymerize the soils, the soil was applied to each plate, and the plates were placed on a hot plate for 2 hours at 400° F. The soiled plates were then weighed.

To clean the plates, each plate was set vertically into a 4 L stainless steel beaker. Thirty (30) grams of the peroxygen/caustic cleaner was applied to each plate. After the mixture was applied, the top of the beaker was sealed with aluminum foil, and steam was applied for 15 minutes. The temperature in the beaker was measured to be between 200° F. and 210° F. for 15 minutes. After 15 minutes, the plates were removed, rinsed, dried and weighed to determine the percent soil removal (% SR).

The following three formulas were tested: Formula 1 comprised 1% Xanthan Gum, 1% of the peroxygen based cleaner, and 2% of NaOH (50%); Formula 2 comprised 1% Xanthan Gum, 2% of the peroxygen based cleaner, and 2% NaOH (50%); Formula 3 comprised 1% Xanthan Gum, 2% of the peroxygen based cleaner, 2% of NaOH (50%), and 0.5% of a commercially available cleaner, Soil Off, available from Ecolab Inc. Two plates were treated with each cleaning formula. The results are shown in the table below.

TABLE 1

| Formula 1 (% SR) | | Formula 2 (% SR) | | Formula 3 (% SR) | |
|---|---|---|---|---|---|
| 40 | 41.8 | 60 | 60.8 | 60.5 | 60.1 |

As can be seen from this table, the Formulas 2 and 3 had similar cleaning results, both of which were better than those of Formula 1. All plates had a tacky residue left on the plates could be removed with minimal scrubbing.

### Example 2

A test was run to evaluate the cleaning capabilities of an all-in-one step gel cleanser when used in combination with steam heat to remove polymerized corn oil soil from stainless steel panels.

Ten (10) grams of corn oil was polymerized onto stainless steel plates using a hot plate. The soils were baked on for 2 hours at a temperature of 400° F.

Soil removal was performed as follows. The soiled plates were set vertically into a 4 L stainless steel beaker. 30 grams of a one-step gel cleaner was added to each plate. The gel cleaner used comprised 1% Xanthan Gum, 2% of the peroxygen based cleaner, 2% NaOH, and 0.5% of a commercially available cleaner, Soil Off, commercially available from Ecolab Inc. After the cleaning composition was applied, the beaker was sealed with aluminum foil and steam was applied for 15 minutes. The plates were then removed, dried, and weighed. The results are shown in the table below.

TABLE 2

| Sample | Soil Removal (%) |
|---|---|
| 1 | 58 |
| 2 | 56.5 |
| 3 | 58.5 |
| 4 | 58.2 |
| 5 | 57.0 |
| 6 | 59.0 |

All of the panels had a tacky residue after cleaning. The residue was easily removed with a scrub pad, and a 0.5% solution of Soil Off®).

### Example 3

The cleaning ability of a gelled all-in-one cleaning composition of the present invention was compared with a commercially available cleaner, Soil Off®), commercially available from Ecolab Inc.

Ten (10) grams of corn oil was polymerized onto stainless steel plates using the hot plate. The soils were baked on for 2 hours at a temperature of 400° F. This is the smoke point of the oil.

Soil removal was performed as follows. The soiled stainless steel plates were placed vertically into a 4 L stainless steel beaker. 20 grams of each solution was applied to the soiled panels, and the top of the beaker was sealed with aluminum foil. Steam was then applied for 15 minutes. The temperature in the beaker was measured to be between 200° F. and 210° F. for 15 minutes. After the reaction, the panels were rinsed, dried, and weight for % SR.

The two formulas tested were: Formula 1 comprised 1% of Xanthan Gum, 2% of the peroxygen based cleaner, 2% of NaOH (50%), and 0.5% Soil Off®); Formula 2 comprised 1% Xanthan Gum, 2% NaOH (50%), and 0.5% Soil Off®). The results are shown in the table below.

TABLE 3

| Formula 1 (% SR) | | | Formula 2 (% SR) | | |
|---|---|---|---|---|---|
| 52 | 52.8 | 50.4 | 30.4 | 34.1 | 30.86 |

As can be seen from this table, the Formula using an all-in-one gelled composition of the present invention achieved higher soil removal than the samples treated with Soil Off®) alone.

### Example 4

A gelled caustic solution was compared against a gelled all-in-one cleaning composition of the present invention.

10 grams of corn oil was polymerized onto stainless steel panels using a hot plate. The soiled plates were heated for two hours on a temperature of 400° F.

After the soil was polymerized, each plate was placed in a 4 L stainless steel beaker and 20 grams of one of the gelled mixtures was applied. Aluminum foil was put on top of the beaker and stem heat was applied for 15 minutes. The temperature in the beaker was measured to be between 200° F. and 210° F. for 15 minutes. After cleaning the plates were rinsed, dried, and weighed for percent soil removal. The following two formulas were used: Formula 1 comprised 1% Xanthan gum, 2% of the peroxygen based cleaner, 3% of NaOH (50%), and 0.5% Soil Off®); Formula 2 comprised 1% Xanthan gum, 3% NaOH (50%), and 0.5% Soil Off®). The results are shown in the table below.

TABLE 4

| | |
|---|---|
| Formula 1 | Formula 2 |
| (% SR) | (% SR) |

| | | | |
|---|---|---|---|
| 58.4 | 54.5 | 28.4 | 29.9 |

As can be seen from this table, the plates treated with a composition of the present invention, i.e., Formula 1, had a much higher percent soil removed than those treated with the caustic solution.

### Example 5

A test was run to measure the soil removal from stainless steel plates using a composition of the present invention with heat.

10 grams of corn oil was polymerized onto stainless steel plates by heating the plates on a hot plate for 2 hours at 400° F.

After polymerization, the plates were put on to a hot plate, and 20 grams of a gelled all-in-one composition of the present invention was applied to each plate. The composition tested comprised 1% Xanthan Gum, 2% of the peroxygen based cleaner, 2% NaOH (50%), and 0.25% Soil Off®). The plates were then heated to a temperature of 180° F. The heat was applied for about 10 minutes. The plates were then cooled, drained, rinsed, and allowed to air dry. The percent soil removal was then determined. The table below shows the results of this test.

TABLE 5

| Sample | Formula 1 (% SR) |
|---|---|
| 1 | 70 |
| 2 | 70.8 |
| 3 | 65.1 |
| 4 | 68.8 |

As can be seen from this chart, an effective amount of soil removal was achieved using the methods and compositions of the present invention.

### Example 6

A test was run to compare the cleaning abilities of an all-in-one gelled composition of the present invention to a gelled caustic composition, using a hot plate for activation of each of the cleaning chemistries.

10 grams of corn oil was polymerized onto stainless steel plates. The soil was applied, and polymerized by heating on the hot plate for 2 hours at 400° F. Plates were run one at time by adding 20 grams of one of the cleaning compositions to each plate and heating to between 180° F. and 190° F. for 15 minutes. For the samples tested with the caustic solution, the composition was applied, and then the temperature was raised to 180° F. Once that temperature was reached, the composition remained on the plates for 15 minutes at a temperature of between about 180° F. and 190° F. The composition of the present invention (Formula 1) comprised: 1% Xanthan Gum, 2% of the peroxygen based cleaner, 2% NaOH (50%), and 0.25% Soil Off®). The gelled caustic solution (Formula 2) comprised: 1% Xanthan Gum, 2% NaOH (50%) and 0.25% Soil Off®). The results are shown in the table below.

TABLE 6

| Formula 1 | | | Formula 2 | | |
|---|---|---|---|---|---|
| (% SR) | | | (% SR) | | |
| 65.1 | 62.8 | 64.7 | 31 | 40.1 | 43.5 |

As can be seen from this table, the plates cleaned with a composition of the present invention (Formula 1) achieved a much greater soil removal than those plates cleaned with just a gelled caustic composition.

### Example 7

A test was run to determine the effects of concentration level of the peroxygen based cleaner in a composition of the present invention.

10 grams of corn oil was polymerized onto stainless steel plates for two hours using a hot plate. 20 grams of the following composition was applied to each plate: 1% Xanthan Gum, 3% of the peroxygen based cleaner, 2% NaOH, and 0.5% Soil Off®). The temperature of each plate was then raised to about 180° F. The composition was allowed to sit on the plate for about 15 minutes at this temperature. After 15 minutes, the plates were rinsed, dried, and weighed. The table below shows the percent soil removal achieved.

TABLE 7

| | Soil Removal |
|---|---|
| Sample | (%) |
| 1 | 63.4 |
| 2 | 60.4 |
| 3 | 61.22 |
| 4 | 62.2 |

As can be seen from this table, an effective level of soil removal was achieved. These results are similar to the results seen when using the composition of the present invention with heat, with a lower concentration of the peroxygen based cleaner.

### Example 8

A test was run to evaluate the cleaning performance of a composition of the present invention in combination with a solvent/surfactant.

10 grams of corn oil was polymerized on stainless steel plates for two hours at a temperature of 400° F. Once the soil was polymerized, 20 grams of a composition of the present invention was applied to the plate. The composition used comprised 1% Xanthan Gum, 2% of a peroxygen based cleaner, 2% of NaOH (50%). The composition also comprised 0.5% of Klenzmax TFC Green®, available from Ecolab Inc., as a solvent/surfactant additive. After the composition was applied, the plates were heated to about 180° F. The plates were maintained at a temperature of between 180° F. and 190° F. for 15 minutes. The table below shows the percent soil removed.

TABLE 8

| | Soil Removal |
|---|---|
| Sample | (%) |
| 1 | 58.4 |
| 2 | 62.1 |
| 3 | 61.4 |
| 4 | 60.8 |

As can be seen from this table, use of a solvent/surfactant additive did not significantly enhance the soil removal capabilities compared to the compositions of the present invention previously tested that did not have a solvent/surfactant added.

### Example 9

A test was run to compare the ability of a gelled composition of the present invention to a gelled caustic solution to remove a carbonized barbeque (BBQ) sauce soil.

20 grams of BBQ sauce was carbonized onto stainless steel panels by applying the BBQ sauce to the panels, and then heating the panels for about 2 hours at a temperature setting of #6. After the panels were cooled, 20 grams of a composition of the present invention (Formula 1) or a gelled caustic composition (Formula 2) were applied to the individual panels. The panels were then heated to 180° F., and the temperature was maintained between 180° F. and 190° F. for 15 minutes. Formula 1 comprised 1% Xanthan Gum, 2% of a peroxygen based cleaner, 2% of NaOH (50%), and 0.5% Soil Off®). Formula 2 comprised 1% Xanthan Gum, 2% NaOH, and 0.5% Soil Off®). The percent soil removal was then measured. The results are shown in the table below.

TABLE 9

| Formula 1 (% SR) | | | Formula 2 (% SR) | | |
|---|---|---|---|---|---|
| 92.1 | 90.15 | 88.40 | 60.10 | 62.84 | 60.88 |

As can be seen from this table, the panels treated with a composition of the present invention (Formula 1) had a much higher soil removal percentage than those treated with a gelled caustic solution. Overall, a much higher soil removal rate using a composition of the present invention was found when removing carbonized BBQ soil compared to removing polymerized corn soil.

### Example 10

A test was run to determine the cleaning ability of a gelled composition of the present invention to remove carbonized BBQ sauce soils from stainless steel.

20 grams of BBQ sauce was spread onto four stainless steel plates. Two of the plates were placed in a 90° C. oven for 6 hours, and 2 of the plates were heated on a hot plate for 2 hours to carbonize the soil. 20 grams of a composition of the present invention was then spread onto the soiled plates. The composition used for this experiment (Formula 1) comprised 1% Xanthan Gum, 2% of the peroxygen based cleaner, 2% of NaOH (50%), and 0.5% Soil Off. The plates were then heated to 180° F., and remained at that temperature for 15 minutes. The plates were then rinsed, drained, dried, and weighed to determine the percent soil removal. The table below shows the results.

TABLE 10

| | |
|---|---|
| Plates heated | Plates heated |
| in a 90° C. | on a |
| oven | hot plate |
| (% SR) | (% SR) |

| | | | |
|---|---|---|---|
| 40.1 | 36.8 | 82 | 80.6 |

As can be seen, the plates which had the soil heated in a 90° C. oven for 6 hours had a lower percent soil removal when treated with a composition of the present invention, than the plates heated on a hot plate. It was observed that when the composition of the present invention contacted the soil on the plates heated on a hot plate, a large amount of oxygen gas evolved from the solution. The same did not occur when the composition was applied to the plates heated in a 90° C. oven.

Another test was run to determine the ability of a composition of the present invention to remove baked on BBQ sauce from stainless steel panels. 20 grams of BBQ sauce was spread onto stainless steel panels, and placed in a 90° C. oven to carbonize for 8 hours. After 8 hours, 20 grams of Formula 1 was applied to each panel, and heated on a hotplate to start the reaction 180° F. The plates were maintained at this temperature for 15 minutes. After 15 minutes, the plates were rinsed, dried and weighed to determine the percent soil removed. The results are shown in the table below.

TABLE 11

| | Soil Removal |
|---|---|
| Sample | (%) |
| 1 | 34.4 |
| 2 | 38.2 |
| 3 | 40.10 |
| 4 | 35.4 |

As can be seen from this table, again a lower percent soil removal was seen under these conditions. It was observed that the reaction did not generate the usual amount of oxygen.

### Example 11

A test was run to compare the soil removal abilities of a commercially available oven cleaner, Easy Off®) to a composition of the present invention (Formula 1). The composition of the present invention comprised 1% Xanthan Gum, 2% of the peroxygen based cleaner, 2% of NaOH (50%) and 0.5% Soil Off. Two separate soils were tested.

20 grams of BBQ sauce was carbonized onto stainless steel panels by applying the BBQ sauce to the panels, and then heating the panels for about 2 hours at a temperature of 400° F. In addition, four grams of corn oil was polymerized onto stainless steel plates using the hot plate for about 2 hours at a temperature of 400° F. 20 grams of either cleaning composition was then applied to the soiled panels. The panels were then heated to 180° F. and maintained between 180° F. and 190° F. for about 15 minutes. The results are shown in the table below.

TABLE 12

| | | | |
|---|---|---|---|
| Sample | Easy Off | Sample | Formula 1 |

| | |
|---|---|
| BBQ Sauce | BBQ Sauce |

| | | | |
|---|---|---|---|
| 1 | 24.7 | 1 | 75.8 |
| 2 | 29.1 | 2 | 74.1 |
| 3 | 28.62 | | |
| 4 | 26.45 | | |

| | |
|---|---|
| Corn Oil | Corn Oil |

| | | | |
|---|---|---|---|
| 1 | 31.1 | 1 | 50.24 |
| 2 | 30.3 | 2 | 54.61 |

As can be seen from this table, the Easy Off oven cleaner did not remove the carbonized BBQ sauce or polymerized corn oil from the panels as well as the composition of the present invention. The Easy Off oven cleaner removed an average of 27% of the carbonized BBQ sauce with a maximum removal of 29% and it removed an average of 30.7% polymerized corn oil with a maximum removal of 31.1%

The gelled peroxide/caustic removed an average of 74.95% of the carbonized BBQ sauce with a maximum removal of 75.8% and it removed an average of 52.4% of the polymerized corn oil with a maximum of 54.61%

### Example 12

### Use of Molybdate to Lower Activation Temperature of Gelled Peroxide Oven Cleaner

A test was performed to determine the cleaning ability of a solution of the gelled peroxide/caustic with added Molybdate against a solution of the gelled peroxide/caustic (without added molybdate) and against a solution containing only the gelled caustic. 40 grams of commercially available barbeque sauce was carbonized onto stainless steel plates using the hot plate for about 2 hours at a temperature of 400° F. 30 grams of each cleaning composition was then applied. The panels were then heated to 130° F. and maintained between 130° F. and 140° F. for 20 minutes. Formula 1 contained 1% Xanthan Gum, 2% peroxygen based cleaner, 2% NaOH (50%), and 0.5% Soil Off®). Formula 2 contained 1% Xanthan Gum, 2% peroxygen based cleaner, 2% NaOH (50%) and composition that provided 40 ppm Mo as an activator complex. Formula 3 contained 1% Xanthan Gum, 2% NaOH (50%) and 0.5% Soil Off®). The results are shown in the table below.

TABLE 13

| Formula 1 (% SR) | | Formula 2 (% SR) | | Formula 3 (% SR) | |
|---|---|---|---|---|---|
| 4.06 | 4.71 | 24.92 | 27.60 | 2.81 | 3.93 |

As can be seen from this table, with the addition of the molybdate activator complex (Formula 2), at this reduced temperature (130° F.), there was higher percent of soil removal than the formulations that did not contain molybdate as an activator.

### Other Embodiments

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

In addition, the contents of all patent publications discussed supra are incorporated in their entirety by this reference.

It is also to be understood that wherever values and ranges are provided herein, e.g., time, temperature, amount of active ingredients, all values and ranges encompassed by these values and ranges, are meant to be encompassed within the scope of the present invention. Moreover, all values that fall within these ranges, as well as the upper or lower limits of a range of values, are also contemplated by the present application.

1. A method for removing soil from a hard surface comprising:
(a) manually applying a cleaning composition to the surface, the cleaning composition comprising:
an active oxygen source;
a source of alkalinity;
and about 0.1 wt % to about 4 wt % of a thickening agent, wherein the composition is stable for about 4 to about 72 hours at room temperature, and has a cling time of about 0.1 minutes to about 60 minutes;
(b) activating the composition to generate oxygen gas on and in the soil; and
(c) removing the composition from the surface after an amount of time sufficient to facilitate soil removal.

2. The method of claim 1, wherein the active oxygen source is selected from the group consisting of hydrogen peroxide, a peroxycarboxylic acid and combinations thereof.

3. The method of claim 2, wherein the active oxygen source is present at about 0.1 wt % to about 10 wt %.

4. The method of claim 1, wherein the source of alkalinity is present at about 0.1 wt % to about 40 wt %.

5. The method of claim 1, wherein the source of alkalinity is selected from the group consisting of an alkali hydroxide, an alkaline earth hydroxide, an alkanol amine, a silicate salt, a polyphosphate salt, a carbonate salt, a borate salt and combinations thereof.

6. (canceled)

7. The method of claim 1, wherein the thickening agent is selected from the group consisting of carboxylated vinyl polymers, ethoxylated cellulose, hydroxyethyl styrylamide, polyacrylamide thickeners, xanthan compositions, carrageenan, sodium alginate and algin products, hydroxypropyl cellulose, hydroxyethyl cellulose, quaternary ammonium or amine oxide cationic materials and an anionic counterion, clays, silicates, and combinations thereof.

8. (canceled)

9. The method of claim 1, wherein the cleaning composition further comprises an additional functional ingredient selected from the group consisting of a surfactant, a builder, a buffer, and combinations thereof.

10. The method of claim 9, wherein the builder is selected from the group consisting of HEDP, TKPP, PAA, phosphonobutane carboxylic acid, sodium gluconate, EDTA, NTA, STPP, TSP, sodium glucoheptonate, potassium silicate, sodium silicate, and combinations thereof.

11. The method of claim 9, wherein the surfactant is selected from the group consisting of linear alkyl benzene sulfonates, alcohol sulfonates, amine oxides, linear and branched alcohol ethoxylates, alkyl polyglucosides, polyethylene glycol esters, EO/PO block copolymers, and combinations thereof.

12. The method of claim 1, wherein the step of activating the composition comprises heating the surface to about 160° F. to about 210° F. before the cleaning composition has been applied to the surface.

13. The method of claim 1, wherein the step of activating the composition comprises heating the surface to about 160° F. to about 210° F. after the cleaning composition has been applied to the surface.

14. The method of claim 1, wherein the step of activating the composition comprises contacting the cleaning composition with an activator complex.

15. The method of claim 14, wherein the activator complex is applied to the cleaning composition after the cleaning composition has been applied to the surface.

16. The method of claim 14, wherein the activator complex is applied to the surface before the cleaning composition has been applied to the surface.

17. The method of claim 14, wherein the activator complex is selected from the group consisting of transition metal complexes, enzymes and combinations thereof.

18. The method of claim 17, wherein the transition metal is selected from the group consisting of molybdate, manganese, copper, chromium, iron, cobalt, tin and combinations thereof.

19. The method of claim 1, wherein the composition is applied to the surface for about 1 to about 60 minutes.

20. The method of claim 1, wherein the surface is selected from the group consisting of ovens, fryers, smokehouses, and combinations thereof.

21. The method of claim 1, wherein the soil is a food soil.

22. The method of claim 21, wherein the food soil is a thermally degraded food soil.

23. The method of claim 1, wherein the method further comprises (d) rinsing the surface.

24. A method for removing a food soil from a hard surface comprising:
(a) heating the surface to about 160° F. to about 210° F.;
(b) manually applying a cleaning composition having a cling time of at least about 0.1 minutes to about 60 minutes to the surface, the composition comprising a peroxygen compound, an alkaline detergent, and about 0.1 wt % to about 4.0 wt % of a thickening agent, wherein the composition is stable for about 4 to about 72 hours at room temperature;
(c) removing the composition from the surface after an amount of time sufficient to facilitate soil removal; and
(d) rinsing the surface.

25. A method for removing a food soil from a hard surface comprising:
(a) contacting the surface with an activator complex;
(b) manually applying a cleaning composition having a cling time of at least about 0.1 minutes to about 60 minutes to the surface, wherein the composition comprises a peroxygen compound, an alkaline detergent composition, and about 0.1 wt % to about 4.0 wt % of a thickening agent, wherein the composition is stable for about 4 to about 72 hours at room temperature;
(c) heating the surface to about 120° F. to about 210° F.;
(d) removing the composition from the surface after an amount of time sufficient to facilitate soil removal; and
(e) rinsing the surface.
